(19) United States
(12) Patent Application Publication
(10) Pub. No.: US 2025/0091658 A1
(43) Pub. Date: Mar. 20, 2025

(54) REAR SEAT PLATE FOR A MOTOR VEHICLE BODY

(71) Applicant: BENTELER AUTOMOBILTECHNIK GMBH, Paderborn (DE)

(72) Inventors: Georg FROST, Steinheim (DE); Christian HIELSCHER, Delbrueck (DE); Andreas HITZ, Erwitte (DE); Paul KAUPMANN, Anroechte (DE); Mathias LOHBERG, Altenbeken (DE); Joern TOELLE, Paderborn (DE)

(21) Appl. No.: 18/884,492

(22) Filed: Sep. 13, 2024

(30) Foreign Application Priority Data
Sep. 14, 2023 (DE) 102023124892.8

(51) Int. Cl. B62D 25/20; B60N 2/005; B60R 16/04; B62D 21/15; H01M 50/249

(52) U.S. Cl. CPC B62D 25/2009; B60N 2/005; B60R 16/04; B62D 21/15; H01M 50/249; H01M 2220/20

(57) ABSTRACT

The present disclosure relates to a rear seat plate of a motor vehicle body, including a rear part of a floor plate and a rear seat support, wherein floor plate and rear seat support are vertically offset in relation to one another in the motor vehicle vertical direction (Z), and a tunnel section is optionally formed in the floor plate, and that floor plate and rear seat support are integrally formed via a connecting section as a sheet-metal formed component, in one press stroke, characterized in that a reinforcing structure is formed, and that different strengths and/or different wall thicknesses from one another are formed in different areas.

### RELATED APPLICATIONS

The present application claims priority of German Application Number 10 2023 124 892.8 filed Sep. 14, 2023, the disclosure of which is hereby incorporated by reference herein in its entirety.

### FIELD

The present disclosure relates to a rear seat plate of a motor vehicle body.

### BACKGROUND

Motor vehicles are automobiles which have an internal combustion drive or an electric drive to convey people or also products. Such motor vehicles or automobiles have been produced for many years having a so-called self-supporting body or motor vehicle body. Such a body is welded together from individual metallic components, e.g., steel plate components, but also aluminum components. For this purpose, the individual components of the self-supporting body, such as an.

A-pillar, a B-pillar, a C-pillar, a longitudinal girder, a crossbeam, a roof arch are produced as individual press-formed components and subsequently coupled with one another, e.g., welded, so that the self-supporting body is formed.

The individual components as such are produced with high precision. The joining operation of the individual components sometimes requires further alignments or calibrations, since tolerances are able to arise due to the joining.

### SUMMARY

The object of the present disclosure relates to producing a complete rear seat plate in a simpler and more cost-effective manner, but at the same time to improve its rigidity behavior and crash behavior.

The above-mentioned object is achieved in the case of a rear seat plate on a motor vehicle body. The rear seat plate is intended for a motor vehicle body, and is a complete rear seat plate in this case, and includes a rear part of a floor plate, therefore at least a part of the floor plate in which the passengers on the rear seat of a motor vehicle place their feet. Furthermore, the rear seat plate has a rear seat support, wherein floor plate and rear seat support are arranged vertically offset in relation to one another in the motor vehicle vertical direction. A transmission tunnel section is optionally formed in the floor plate. The floor plate itself and the rear seat support are integrally produced via a connecting section as a sheet-metal formed component and in one press stroke.

According to the present disclosure, the rear seat plate is distinguished in that a reinforcing structure is formed and in that a reinforcing structure is formed in the rear seat plate geometrically and/or by a reinforcing patch and that in different regions different strengths, tensile strengths Rm and/or different wall thicknesses are formed in the rear seat plate.

Integral in the meaning of the present disclosure means that the entire rear seat plate is produced in one press stroke in a forming press. A plate blank is initially provided for this purpose. The plate blank is able to itself be integrally formed from one material, for example, a tailored rolled blank. The plate blank is able to be provided as a tailored welded blank made up of multiple plates of different material quality and/or different wall thickness, however, which are then welded to form a tailored welded blank before the actual forming. The tailored welded blank is then inserted as an integral plate blank into the forming tool. The tailored welded blank is able to be produced by an overlap region, for example, using spot welds. However, the tailored welded blank is able to be produced by abutting placement and subsequent welding, for example laser welding. The same integral plate blank is formed in the case of cold forming. However, the forming is able to take place here in multiple steps, for example, by a following transfer press.

The entire component has a cost-effective and simple production option due to the production in a forming press, since individual components do not each have to be press-formed separately from one another and then joined once again subsequently. The component therefore also has a high precision.

A further advantage is that not only a geometrical high precision is able to be produced in the component. Rather, a corresponding stiffening structure is able to be formed in the component, for example with respect to a high level of stiffness to be achieved, torsional stiffness of the body, and/or is able to be provided by the tensile strength different from one another. Since individual components do not have to be welded once again later, this also has an advantageous effect on the crash properties to be achieved and also offers corresponding corrosion protection. A component is coated in the case of hot forming and press hardening, aluminum-silicon coated, or zinc in the case of cold forming.

In at least one embodiment of the present disclosure, if the hot forming and press hardening technology is applied, a corrosion-resistant, but at the same time also partially high-strength component is able to be provided.

The tensile strength Rm is greater than 1000 MPa in the strong regions, greater than 1350 MPa, greater than 1950 MPa, and, for example, the connecting section is formed with 1500 MPa, greater than 1800 MPa. This has an advantageous effect, on the one hand, on a torsion-resistant body in normal operation of the motor vehicle. The vehicle body therefore also has a high stiffness in the side crash behavior. The floor plate and also the rear seat support, which has connecting sections with other body components, in contrast, are formed softer and therefore have a high ductility, so that other body components do not tear off. An interplay of high crash safety, so that the passenger compartment is protected and torsion-resistant, is achieved in this way.

In at least one embodiment of the present disclosure, a reinforcing bead is formed in the transition from rear seat plate and connecting section and/or at or in a transition from connecting section to floor plate. The reinforcing bead extends over the entire width of the rear seat plate. The width extends in the motor vehicle transverse direction y. The reinforcing bead is oriented in its cross section in the motor vehicle vertical direction or longitudinal direction, respectively. In the installed situation of the rear seat plate in a motor vehicle body, a valley of the bead therefore faces in cross section in the direction of the rear axle. The overall stiffness of the motor vehicle body is also improved in this way. The possibility that the rear seat plate is integrally formed enables a reinforcing bead to be formed in here. If individual parts of the rear seat plate, therefore rear seat support, connecting section, and/or floor plate, were produced individually, among other things a separation point or weld seam would be in the area of the reinforcing bead to be formed, which would just not allow such a production of a reinforcing bead.

In the rear seat plate itself, longitudinal beads are formed. A longitudinal bead is formed in on the outside on the motor vehicle transverse direction in each case, which then extends in the motor vehicle longitudinal direction over the entire length of the rear seat plate. IAttachment options are provided here, in order, for example to couple the rear seat plate to a wheel housing or an inner side wall of a motor vehicle.

In at least one embodiment of the present disclosure, longitudinal beads and/or transverse beads are formed into the floor plate itself.

Furthermore, receptacles for coupling further components, e.g., a battery box or a battery tray, are provided in the floor plate. In at least one embodiment of the present disclosure, screw passage sleeves are provided for this purpose in the floor plate or are coupled thereto. The floor plate is able to be formed locally having a higher tensile strength, so that the weight absorption of up to several hundred kilograms of a corresponding battery box is optionally attached. In at least one embodiment of the present disclosure, longitudinal and/or transverse beads are formed into the floor plate or strip-like sections having a high tensile strength Rm, greater than 1000 MPa, extending in the longitudinal or transverse direction are formed. In this way, a sufficient stiffness for receiving a battery box or battery tray is ensured.

### BRIEF DESCRIPTION OF THE DRAWINGS

Further advantages, features, properties, and aspects of the present invention are the subject matter of the following description. Various embodiments are illustrated in schematic figures. These serve for easy comprehension of the invention. In the figures:

FIG. 1 shows a rear seat plate according to at least one embodiment in a perspective view,

FIG. 2A shows a top view of a rear seat plate according to at least one embodiment,

FIG. 2B shows a front view of the rear seat plate,

FIG. 3A-FIG. 3F show various cross sections of a rear seat plate according to at least one embodiment,

FIG. 4A and FIG. 4B show an alternative embodiment variant of a rear seat plate of the present disclosure,

FIG. 5 shows an alternative embodiment variant of FIG. 4A of the present disclosure,

FIG. 6A and FIG. 6B show further embodiment variants of the present disclosure, and

FIG. 7A-FIG. 7E show various cross-sectional views of a tailored welded blank, in which two plates placed abutting one another are covered by a patch according to at least one embodiment.

### DETAILED DESCRIPTION

In the figures, the same reference signs are used for identical or similar components, even if a repeated description is omitted for reasons of simplification.

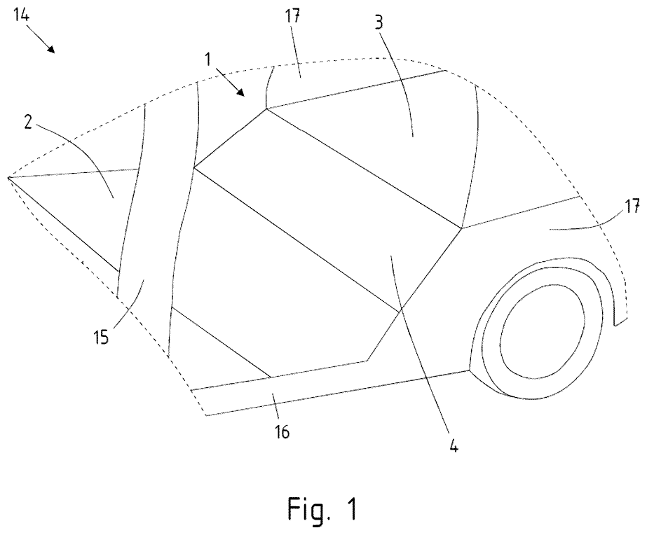

FIG. 1 shows a rear seat plate 1 for use in a motor vehicle body 14 shown in detail. This plate includes a rear part of a floor plate 2. The rear part therefore refers here to the motor vehicle longitudinal direction X. A connecting section 4, which extends diagonally to the rear in the motor vehicle vertical direction Z, is formed between the floor plate 2 and the rear seat support 3. Rear seat support 3, connecting section 4, and floor plate 2 are integrally formed in one press stroke. Optionally, however, a rear part of a transmission tunnel or transmission channel (not shown in more detail) is able to be formed here in the area of the floor plate 2 or the connecting section 4.

Furthermore, a motor vehicle B-pillar 15 is then shown in the front area of FIG. 1. In addition, a rocker panel 16 and a rear side wall 17 are shown. A part of the rear seat plate 1 is coupled from the inside with the respective rear side wall 17. The rear seat plate 1 itself is then coupled in the motor vehicle body 14, for example, welded in. The rear seat plate 1 itself, however, has also been formed as an integral component in one press stroke on a large-format press, also called a giga press.

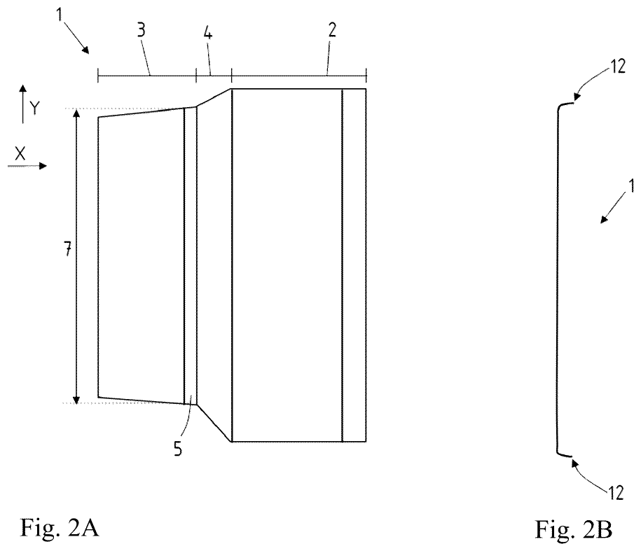

FIG. 2A shows a top view of a rear seat plate 1 according to the present disclosure. The sections floor plate 2, connecting section 4, and rear seat support 3 are again shown.

According to FIG. 2B, a frontal view of the battery tray 11 is also shown. A flange 12 is formed on each of the outer edges by unwinding. This extends in the motor vehicle longitudinal direction X over the entire length of the battery tray 11.

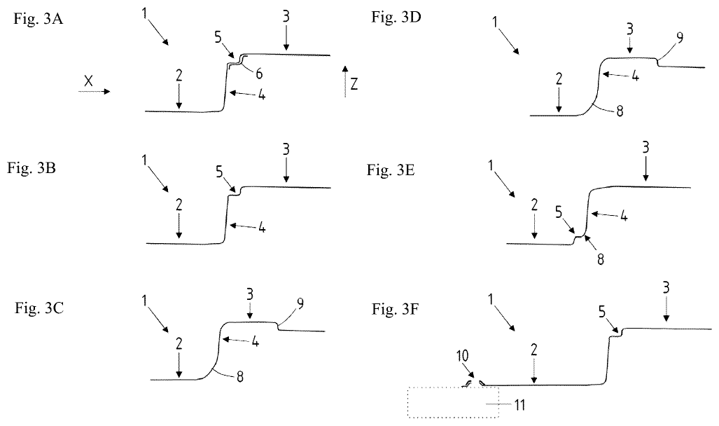

FIG. 3A-FIG. 3F show cross sections different from one another.

According to FIG. 3A, a reinforcing bead 5 is formed in the transition area between connecting section 4 and rear seat support 3. This reinforcing bead 5 is able to form a double layer with an illustrated reinforcing patch 6. Furthermore and additionally, the wall thickness is able to be increased in the area of the reinforcing bead 5. However, the tensile strength Rm is able to be increased in the area of the reinforcing bead 5, for example, more than 1000 MPa. The wall thickness is able to be increased accordingly in the area of the connecting section 4.

FIG. 3B shows an alternative embodiment variant, wherein no reinforcing patch 6 is arranged behind the reinforcing bead 5 here. With a view of FIG. 2A, the reinforcing bead 5 extends over the entire width 7 in the motor vehicle transverse direction Y. The width 7 relates to the width in the area of the rear seat support. However, the width 7 is able to relate to the width of the footwell plate, in the case of the relative specification, according to which the reinforcing bead extends over more than 50% of the width.

According to FIG. 3C, the transition from floor plate 2 to connecting section 4 is formed curved. Furthermore, a further step 9 is formed in the area of the rear seat support 3. The step 9 is able to extend over the entire width 7, but this is not shown in more detail.

FIG. 3D shows an alternative embodiment variant to FIG. 3C.

FIG. 3E shows an embodiment variant. A reinforcing bead 5 is formed in this case in the area of the transition between floor plate 2 and connecting section 4.

FIG. 3F shows an embodiment variant. A receptacle is also formed here in the area of the floor plate 2. The receptacle is used for the coupling with a battery tray 11 or battery box (only indicated) for receiving a motor vehicle battery in the underfloor area.

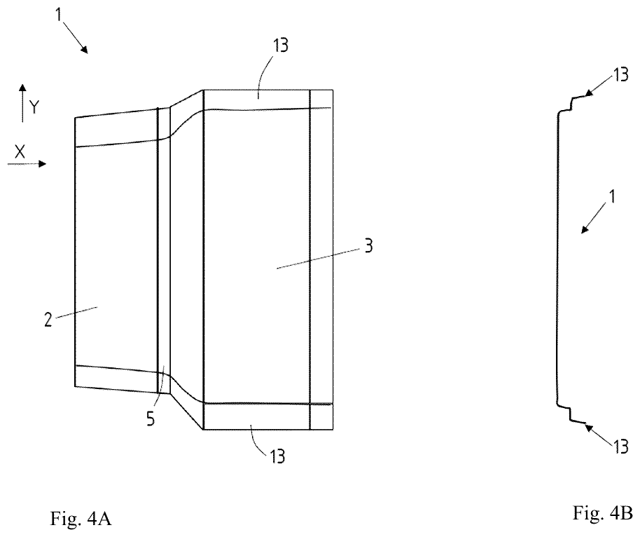

FIG. 4A and FIG. 4B show an alternative embodiment variant thereto. In this case, the respective outer edge is formed in each case as a longitudinal bead 13. This longitudinal bead 13 extends in the motor vehicle X direction of the entire length of the rear seat plate 1. An increased stiffness is able to be provided in this way. All above-mentioned embodiment variants with respect to the reinforcing bead 5 which extends in the motor vehicle transverse direction Y apply analogously to this embodiment variant according to FIG. 4A and FIG. 4B.

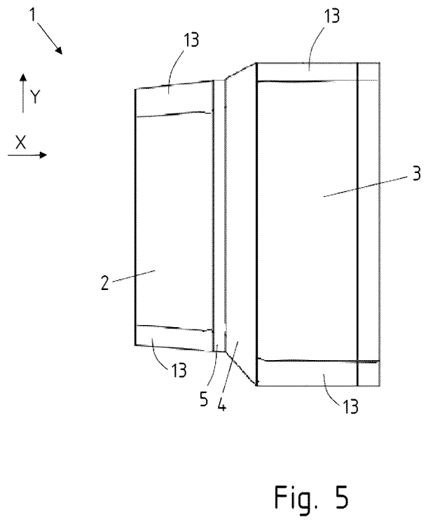

FIG. 5 shows an alternative embodiment variant to FIG. 4A. The longitudinal beads 13 are not formed here in the connecting section 4. The longitudinal beads 13 are therefore only formed in the area of the floor plate and the rear seat support.

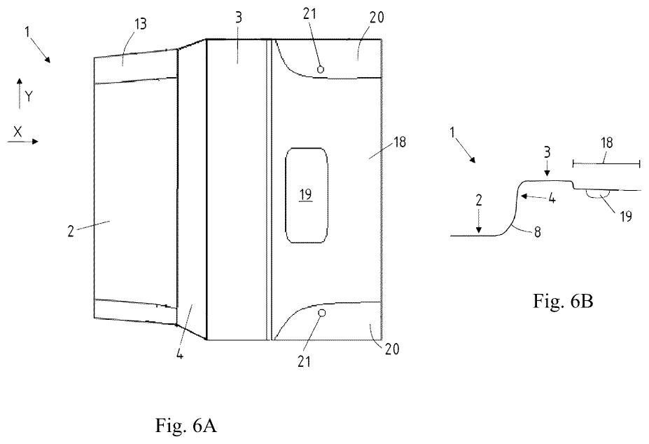

FIG. 6A and FIG. 6B show a further embodiment variant according to the present disclosure. In this case the rear seat support is extended and the motor vehicle longitudinal direction counter to the direction of travel, therefore to the rear. This extension forms a baggage compartment section 18. A receptacle groove 19 for accommodating an energy storage device (not shown in more detail) is housed in the baggage compartment section 18.

Furthermore, a receptacle area 20 for the coupling with wheel arches (not shown in more detail) is able to be formed in the baggage compartment section 18. This receptacle area 20 is designed as reinforced. This means that the reinforcement is formed either by increased tensile strength, e.g., greater than 1000 MPa, and/or a greater wall thickness and/or by a patched area, therefore an area having a plate double-layer spot welded in the tailored welded blank plate. At least one attachment point 21 is formed for the direct coupling with a chassis component, such as a control arm, a shock absorber, or also a suspension strut receptacle. More extensive reinforcement of the body is able to be omitted.

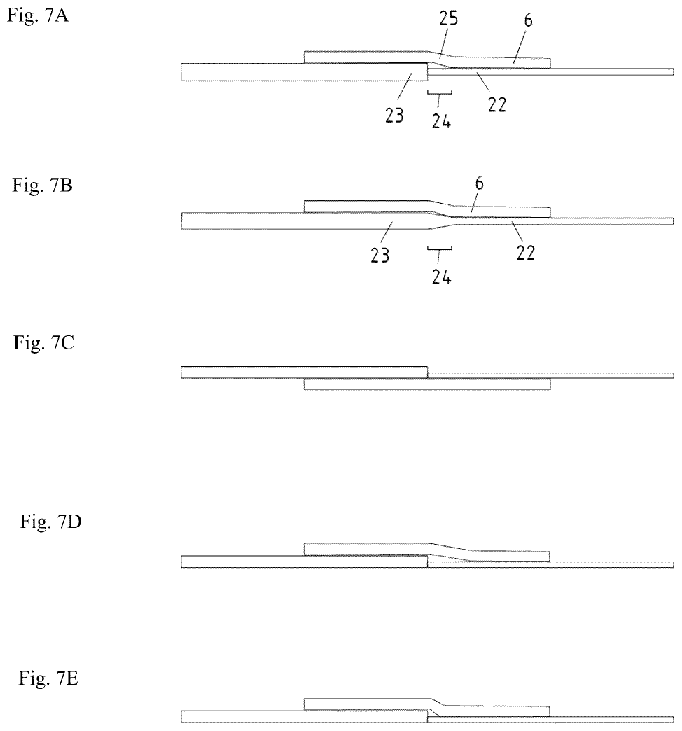

FIG. 7A-FIG. 7E show five different thickness transitions of a plate blank as a tailored welded blank. In each case, a thin plate 22 is butt welded with a thicker plate 23 in relation thereto or, in the case of FIG. 7B, a tailored rolled blank, in which the thickness transition takes place from both side. A reinforcing patch 6 or patch is placed on one side in the area of the thickness jump 24. This patch additionally reinforces the area of the thickness transition. In the case of FIG. 7A, FIG. 7B, FIG. 7D, and FIG. 7E, the reinforcing patch has an angle 25 in its cross section, so the reinforcing patch compensates for the thickness jump 24 or thickness transition. In the case of FIG. 7C, one side of thick plate 23 and thin plate 22 is formed planar, so that the reinforcing patch 6 is likewise formed planar in its cross-sectional course. The lower side of thick plate 23 and thin plate 22 is also formed planar in cross section. The thickness jump 24 is then covered by the patchwork plate, the patches being applied before the actual hot forming process. Undercuts with a corresponding need for, for example, sliders or segmentations of the tool are able to be avoided.

FIG. 7E shows the patched tailored welded blank of FIG. 7D in the state after the hot forming and press hardening. The previously existing gap between patchwork plate and the two plates of the tailored welded blank is formed largely closed due to the hot forming, so that no corrosion problems occur upon a later cathodic dip painting coating of the body and in use of the vehicle. The types of steel used are used as examples hereinafter and are used for all variants of the present disclosure. Various types of steel are able to be combined with one another in a tailored welded blank. Corresponding strength ranges for hard or soft areas or solid or ductile areas are able to be inferred from the table. All alloy components are specified in wt. %, wherein then the remainder made up of iron and smelting-related contaminants are added to the respective hardenable steel alloy.

| TWB section | C | | Si | | Mn | | P | | S | |
|---|---|---|---|---|---|---|---|---|---|---|
| made of | min | max | min | max | min | max | min | max | min | max |
| Hardenable | 0.19 | 0.25 | 0.1 | 0.4 | 1.1 | 1.4 | z | 0.02 | z | 0.005 |
| steel Rm > | | | | | | | | | | |
| 1300 MPa | | | | | | | | | | |
| 22MnB5 Rm | 0.2 | 0.23 | 0.2 | 0.3 | 1.1 | 1.4 | | 0.02 | | 0.005 |
| approx . . . | | | | | | | | | | |
| 1500 MPa | | | | | | | | | | |
| Hardenable | 0.31 | 0.37 | 0.1 | 0.6 | 1 | 1.5 | | 0.025 | | 0.02 |
| steel Rm > | | | | | | | | | | |
| 1750 MPa | | | | | | | | | | |
| 34MnB5 Rm | 0.33 | 0.35 | 0.15 | 0.35 | 1 | 1.5 | | 0.025 | | 0.015 |
| approx . . . | | | | | | | | | | |
| 1900 MPa | | | | | | | | | | |
| Ductile | 0.06 | 0.13 | | 0.7 | | 1.9 | | 0.05 | | 0.05 |
| steel > | | | | | | | | | | |
| 450 MPa | | | | | | | | | | |
| Hardenable | 0.07 | 0.11 | 0.02 | 0.6 | 1.2 | 1.8 | | 0.03 | | 0.01 |
| ductile steel | | | | | | | | | | |
| 800-1000 | | | | | | | | | | |
| MPa | | | | | | | | | | |

| Al | | B | | Cr | | Cu | | N | |
|---|---|---|---|---|---|---|---|---|---|
| min | max | min | max | min | max | min | max | min | max |
| 0 | 0.06 | 0.004 | 0.1 | | 0.3 | z | 0.1 | z | |
| 0 | 0.06 | 0.004 | 0.1 | 0.1 | 0.3 | | 0.1 | | 0.01 |
| | 0.1 | 0.001 | 0.004 | 0.08 | 0.35 | | 0.2 | | 0.2 |
| 0.01 | 0.08 | 0.001 | 0.004 | 0.08 | 0.5-Mo | | 0.2 | | 0.2 |
| | 0.1 | | 0.003 | | 0.15 | | 0.2 | | 0.2 |
| 0.01 | 0.07 | 0.0007 | 0.002 | | 0.15 | | 0.2 | | 0.2 |

| Nb | | Ni | | Ti | | V | | Mo | |
|---|---|---|---|---|---|---|---|---|---|
| min | max | min | max | min | max | min | max | min | max |
| | 0.05-Ti | 0.02 | 0.1 | 0.01 | 0.1 | z | | z | 0.35 |
| | 0.05-Ti | 0.02 | 0.1 | 0.02 | 0.05 | | 0.01 | | 0.35 |
| | 0.1 | | 0.2 | 0.002 | 0.05 | | | | 0.35 |
| 0.01 | 0.06 | | 0.2 | 0.005 | 0.015 | | 0.01 | | 0.5-Cr |
| | 0.1 | | | | 1.2 | | 0.1 | | 0.1 |
| 0.04 | 0.1 | | | 0.03 | 0.2 | | 0.1 | | 0.1 |

The foregoing description of some embodiments of the disclosure has been presented for purposes of illustration and description. The description is not intended to be exhaustive or to limit the disclosure to the precise form disclosed, and modifications and variations are possible in light of the above teachings. The specifically described embodiments explain the principles and practical applications to enable one ordinarily skilled in the art to utilize various embodiments and with various modifications as are suited to the particular use contemplated. Various changes, substitutions and alterations can be made hereto without departing from the spirit and scope of the disclosure.

1-8. (canceled)

9. A rear seat plate of a motor vehicle body, comprising:
a rear part of a floor plate and a rear seat support,
wherein the floor plate and the rear seat support are vertically offset relative to each other in a motor vehicle vertical direction, and the floor plate and the rear seat support are integrally connected via a connecting section as a sheet metal component,
wherein a reinforcing structure is formed, and different strengths or different wall thicknesses from one another are formed in different areas,
wherein a transition from the rear seat plate and the connecting section or at a transition from the connecting section to the floor plate, is a reinforcing bead which extends over more than 50% of a width, and the reinforcing bead is oriented in cross section toward a rear axle of the motor vehicle body.

10. The rear seat plate as claimed in claim 9, wherein the rear part of a floor plate and a rear seat support comprises a hot-formed and press-hardened component formed in one press stroke.

11. The rear seat plate as claimed in claim 9, wherein a high-strength area has a tensile strength greater than or equal to 1350 MPa.

12. The rear seat plate as claimed in claim 9, wherein a soft area has a tensile strength Rm less than 1000 MPa.

13. The rear seat plate as claimed in claim 9, wherein a reinforcing patch is disposed at least locally.

14. The rear seat plate as claimed in claim 9, wherein the connecting section has a tensile strength Rm greater than 1350 MPa.

15. The rear seat plate as claimed in claim 9, wherein the rear seat support comprises longitudinal beads which extend in a motor vehicle longitudinal direction over an entire length of the rear seat support or receptacles for coupling a battery box.

16. The rear seat plate as claimed in claim 9, wherein longitudinal beads or receptacles for coupling a battery box or screw passage sleeves, are in a footwell plate.

17. The rear seat plate as claimed in claim 9, wherein the floor plate comprises a tunnel section.

18. The rear seat plate as claimed in claim 9, wherein the floor plate and the rear seat support are formed in one press stroke.

19. The rear seat plate as claimed in claim 9, wherein the reinforcing bead extends over the entire width of the rear seat plate.

20. The rear seat plate as claimed in claim 9, wherein the soft area has a tensile strength Rm less than 850 MPa.

21. The rear seat plate as claimed in claim 9, wherein the connecting section has a tensile strength Rm greater than 1800 MPa.

22. The rear seat plate as claimed in claim 9, wherein longitudinal beads or receptacles are for coupling a battery box.
